(19) United States
(12) Patent Application Publication
(10) Pub. No.: US 2004/0065117 A1
(43) Pub. Date: Apr. 8, 2004

(54) Method and device for producing optical elements with at least one curved surface

(75) Inventors: Yaolong Chen, Aalen (DE); Karl-Heinz Schuster, Koenigsbronn (DE)

Correspondence Address: WELSH & KATZ, LTD, 120 S RIVERSIDE PLAZA, 22ND FLOOR, CHICAGO, IL, 60606, US

(73) Assignee: Carl Zeiss SMT AG, Oberkochen (DE)

(21) Appl. No.: 10/601,922

(22) Filed: Jun. 23, 2003

(30) Foreign Application Priority Data
Jul. 25, 2002 (DE) 102 33 777.2

(51) Int. Cl. C03B 33/00

(52) U.S. Cl. 65/112; 264/1.21; 264/1.32; 83/879; 65/174

(57) ABSTRACT

In the case of a method for producing an optical element with at least one curved surface by spherical separation, a spherical-cap-like separating body with cutting elements is used. The separating body is in this case moved in a pivoting movement through a basic body or the basic body is moved through the separating body, a relative rotational movement taking place between the basic body and the separating body with a rotating axis which passes through the center point (M) of the pivoting movement.

### BACKGROUND OF THE INVENTION

1. Field of the Invention

The invention relates to a method for producing optical elements with at least one curved surface by spherical separation.

The invention also relates to a device for producing optical elements with at least one curved surface by spherical separation with a spherical-cap-like separating body.

2. Description of the Related Art

It is generally known for lenses to be produced by sawing them out from plane-parallel plates or by being pressed as drops of softened glass into a mold, the mold corresponding to the unfinished shape or finished shape of the finished lens. After the drop of glass has cooled down in the mold, either no surface machining operations are required, or only the customary fine-optical machining operations.

When producing semiconductor elements in projection exposure installations with projection lenses, lenses of quartz glass or crystal, such as for example calcium fluoride, have to be used on account of the increasingly shorter wavelengths. The characteristic of quartz glass is that it cannot be shaped into the desired geometry close to that of the final lens without loss of quality with respect to homogeneity and transmission. The crystals cannot in principle undergo shaping.

The production of a lens from a plate as a blank with the curved surfaces to be formed into it is very complex and costly.

### SUMMARY OF THE INVENTION

The present invention is therefore based on the object of providing a method and a device with which optical elements with at least one curved surface, such as for example lenses, in particular lenses of quartz glass or crystals, can be produced in a simple and cost-saving way. At the same time it is also intended to take into account the problems occurring when machining crystals, such as for example sensitivity to vibrational energies and thermal loads which may lead to destruction of the crystal.

This object is achieved according to the invention by spherical separating methods with a spherical-cap-like separating body, the separating body being moved through a basic body or the basic body being moved through the separating body in a pivoting movement, while at the same time a relative rotational movement takes place between the basic body and the separating body with a rotating axis which passes through the center point M of the pivoting movement.

A device according to the invention for producing an optical element with at least one curved surface from a basic block is provided with a spherical-cap-like separating body with cutting elements, the separating body or the basic body being pivotable around a pivoting axis with a curvature about a pivoting center point M which corresponds to the curvature of the separating cut to be introduced into the basic block, and the basic body being accommodated in a receptacle.

In the case of the method according to the invention and the device for it, the unfinished form of an optical element with the desired curved surface is removed by the spherical-cap-like separating body in one operation. The separation can in this case be performed in a harmless way, so that disadvantageous effects on lenses of crystals are avoided and they are consequently not damaged or destroyed.

A very advantageous development of the invention consists in that at least two optical blanks for the optical element are removed from the basic body in such a way that a concave side of a first optical element and a convex side of a second optical element are formed simultaneously by a single separating cut.

With this development according to the invention it is possible, for example, for two unfinished forms of lenses to be produced in one operation, which saves not only optical material but also costs and time.

In particular when spherically separating calcium fluoride, particularly low-loss and low-vibration spherical separation is required, since calcium fluoride is extremely expensive and mechanically highly sensitive.

As an alternative to a spherical-cap-like separating body, which is essentially at least approximately in the form of a bell, in one configuration of the invention it may be provided that the separating body has a part-spherical shell, which is provided in the region of the pivoting axis of the separating body with a bore in which the basic body can be accommodated with its receptacle, and that the part-spherical shell is held on its outer circumferential wall on the separating body by means of a holding device, the cutting elements being arranged on the inner circumference of the part-spherical shell.

In the case of this configuration, the separating body has in its center a large central opening. The basic body enters into this opening as the optical element to be machined. The separating cut then takes place during the pivoting movement of the separating body or else of the optical element.

In practice, this form of separating body represents a spherically curved ring, which is supported on the outside by means of the holding device.

In the case of this configuration of the invention, the separating body may be formed very rigidly on its outer circumference, for example in the form of a cylindrical housing.

In addition or as an alternative, the separating body may be secured on its outer circumferential wall or be supported on a fixed machine part by means of a rotary bearing lying in between.

This configuration allows the separating body to be made much more rigid and absorb or transfer greater forces which are introduced via the cutting elements.

In addition, the risk of vibrations is distinctly lower and vibrations occurring are also dissipated considerably more quickly.

In addition, the part-spherical shell in the form of the spherically curved ring may correspondingly also be provided with damping elements, which may also be displaceable individually under open-loop or closed-loop control.

To avoid harmful vibrations and thermal loads, the separating body, in particular in the case of a configuration in the form of a bell, will be correspondingly formed, such as for example with a vibration-damping construction, a division into two, an arrangement of depressions in the surface of the separating body, in particular of irregular depressions, such as for example grooves, a trapezoidal or wedge-shaped form of the cutting elements and/or their irregular arrangement on the separating body, cooling ducts with forced cooling and the like.

Advantageous developments and configurations of the invention emerge from the remaining subclaims and from the exemplary embodiment described in principle below on the basis of the drawing, in which:

### BRIEF DESCRIPTION OF THE DRAWINGS

FIG. 1 shows a basic representation of a device for producing a lens from a basic body;

FIG. 2 shows a section through a spherical-cap-like separating body;

FIG. 3 shows a basic representation of the production of two optical blanks from a basic body;

FIG. 4 shows a plan view of a configuration of a spherical-cap-like separating body;

FIG. 5 shows in the form of a detail part of the developed projection of the circumferential wall of a separating body;

FIGS. 6a and 6b respectively show in the form of a detail a circumferential portion of a separating body in other configurations;

FIG. 7 shows a configuration of the separating body with a part-spherical shell in the form of a spherically curved ring;

FIG. 8 shows an enlarged representation of the exemplary embodiment according to FIG. 4 with part of the spherically curved ring and the fastening on the separating body;

FIG. 9 shows the part-spherical shell with integrated damping elements;

FIG. 10 shows a part-spherical shell in the form of a spherically curved ring in the normal configuration;

FIG. 11 shows a part-spherical shell with damping elements arranged on the side faces;

FIG. 12 shows the lower region of a separating body with the part-spherical shell and with displaceable damping elements;

FIG. 13 shows the plan view of the separating body with the displaceable damping elements according to FIG. 12;

FIG. 14 shows a basic representation in the form of a detail of a device for producing a lens from a basic body with the separating body represented in FIG. 7; and

FIG. 15 shows a basic representation with respect to the rotating and pivoting movements along with the curve of intersection of the separating body and the basic body.

### DETAILED DESCRIPTION

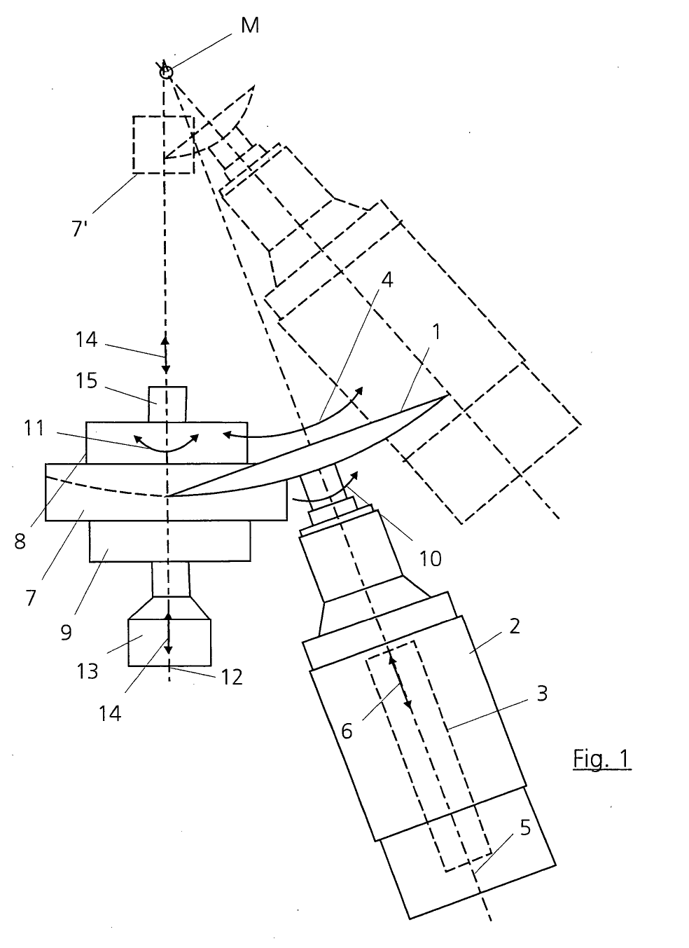

A spherical-cap-like separating body 1 is connected in a way not represented in any more detail to a rotary drive device 2. The rotary drive device 2 is arranged in a way not represented in any more detail on a pivoting element 3 or is connected to it. Together with the rotary drive device 2, the pivoting element 3 performs a pivoting movement in the direction of the arrow 4 about a pivoting center point M. The pivoting element 3 is fixedly displaceable, together with the rotary drive device 2, along the pivoting axis 5 through the pivoting center point M according to the direction of the arrow 6. In this way, various pivoting radii can be set. It must be noted, however, that the radius of the spherical cap of the separating body 1 must correspond in each case to the pivoting radius. This means that the separating body 1 must be correspondingly exchanged or respectively adapted. In FIG. 1, the position of a separating body with its rotary drive device for carrying out a separating cut on a smaller blank 71 is additionally indicated by dashed lines.

The separating cut which is to be introduced into a basic body 7 and corresponds to the curvature of the lenses to be formed from the basic body 7 must likewise correspond to the pivoting radius about the pivoting center point M. The basic body 7 is held on both sides between two receptacles 8 and 9. This may take place for example hydraulically, pneumatically or by mechanical means. In a preferred way, a vacuum device is used for this, to be able to exert axial tensile forces on the basic body 7 to be separated during a separating cut, in order that jamming in the separating gap does not occur during the separating cut. The separating body 1 rotates in the direction of the arrow 10 around the pivoting axis 5. At the same time, the basic body 7 likewise rotates in the direction of the arrow 11 around a rotating axis 12, which passes through the pivoting center point M. The receptacle 9 is arranged on a drive device 13 (not represented in any more detail), by which a displacement in the direction of the arrow 14 along the axis 12 is possible. The receptacle 8 has a follower drive device 15, by which a displacement of the receptacle 8 in the direction of the arrow 14 is likewise possible.

To produce two lens blanks 16 and 17 from the basic body 7, one blank having a concave form and the second blank having a convex form (see FIG. 3), the spherical-cap-like separating body 1 rotating around the pivoting axis 5 is pivoted into the basic body 7 in the direction of the arrow 4. As this happens, the cutting elements 18 of the separating body 1, which are arranged in a distributed manner on the circumference, produce a separating cut 19 in a way corresponding to the width of the cutting elements 18. On account of the simultaneous rotation of the basic body 7 around the rotating axis 12, for separating the basic body 7 it is merely necessary to introduce the separating body 1 as far as the rotating axis 12.

During the separating operation, it must be ensured that the optical lens blanks 16 and 17 obtained are securely held by the receptacles 8 and 9 without jamming with respect to the separating gap 19. The same applies after carrying out the separation. After completion of the separating operation, the two receptacles 8, 9 are moved back, or at least one of the two receptacles is moved back, to allow the lens blanks 16 and 17 to be removed. A corresponding displacement of the receptacles 8 and 9 in the direction of the arrow 14 brings about an adaptation to different thicknesses of a basic body 7 and to different pivoting radii.

A wide variety of devices are possible as drive devices 13 and 15 for the displacement of the receptacles 8 and 9.

For example, spindle drives may be used for this purpose, one spindle drive being provided for one receptacle, while the other spindle may act merely as a follower and be coupled synchronously to the driven spindle.

If a vacuum device is used for the two receptacles 8 and 9, not only are the two blanks 16, 17 received without harming them, but at the same time a slight tensile force is exerted on them, so that instances of jamming are avoided. At the same time, in this case both blanks 16 and 17 are respectively held securely once the basic body 7 has been cut through.

Any desired known devices are possible for the various in-feeding and pivoting movements of the rotary drive device 2 and the receptacles 8 and 9, for which reason they are not described in any more detail.

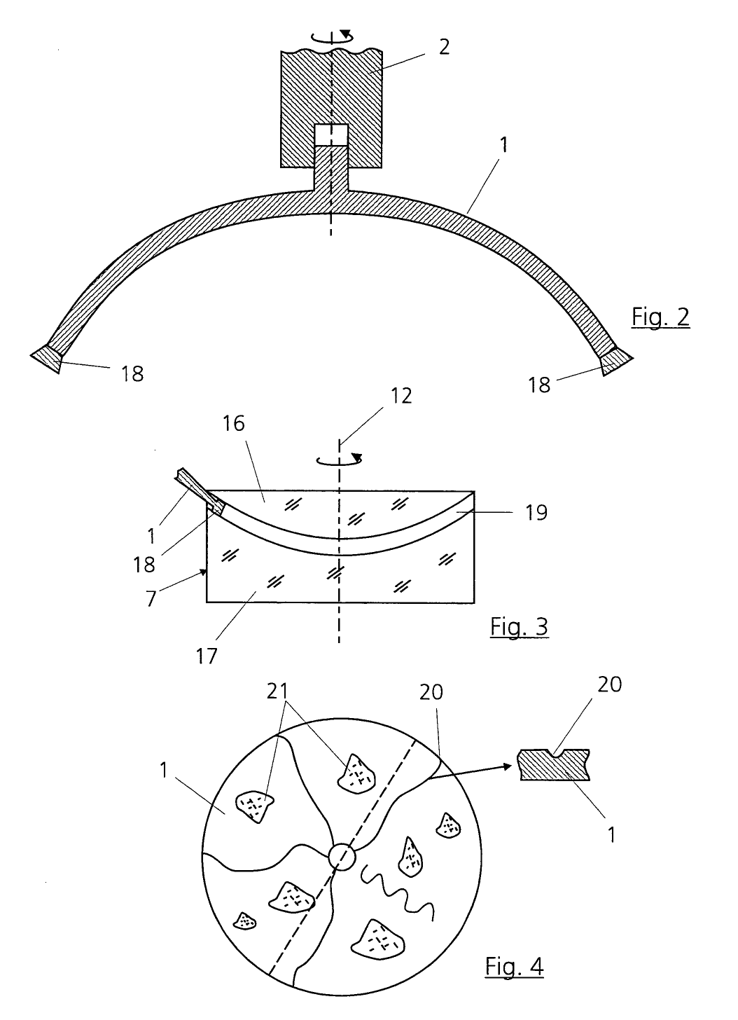

As can be seen from FIG. 2, the separating body 1 has a spherical-cap-like form or a thin-walled spherical shell. To carry out the separating cut, it is not absolutely necessary for both the separating body 1 and the basic body 7 to rotate. It is merely necessary that there is a relative rotational movement between the two parts. If only the separating body 1 rotates, the separating body 1 must be pivoted completely through the basic body 7 to carry out a separating cut.

If lenses of crystalline material, for example of calcium fluoride, are to be spherically separated, various precautions should be taken and configurations provided during the separating cut to avoid the occurrence of any harmful vibrational energies and thermal loads which may lead to destruction of the crystals.

One possibility for this is that the spherical-cap-like separating body 1 is divided into two or three (see dashed line in FIG. 4). In addition, depressions in the form of grooves 20 may be made in the surface, preferably such that they are distributed irregularly over the circumference of the separating body 1 and also run irregularly radially (see FIG. 4). A one-part spherical cap can also be separated or cut into locally, for example in a wave form, as shown in one region in FIG. 4. This prevents the occurrence of a uniform resonant frequency of the spherical cap with high amplitude. The grooves 20 have a dual function. On the one hand, they break down the oscillation frequency of a closed plate or spherical shell into many different individual frequencies and, on the other hand, the grooves 20 can be used at the same time for forcing cooling lubricant from the rotating axis to the fittings or cutting elements 18 at the circumference. The depressions may also pass completely through the separating body 1.

When the separating body 1 is being assembled from a number of individual spherical caps or individual spherical cap parts, the individual parts can be connected to one another by adhesion over part of or the full surface area. In the case of a relatively thick adhesive layer, for example with a filling of tungsten powder, very good passive vibration damping effects can be achieved at the same time. Another possibility is to provide on the surface of the separating body 1 variously shaped and differently arranged adhesive areas 21, which likewise counteract the occurrence of vibrations.

The cutting elements 18 or the fittings are arranged such that they are distributed irregularly over the circumference. As can be seen from FIG. 2, when seen in cross section, the cutting elements 18 have the form of a wedge or trapezoid, the front side being wider, whereby a freely cutting separating cut is achieved. At the same time, in this way lateral friction is avoided, which likewise has positive effects on lower heat generation.

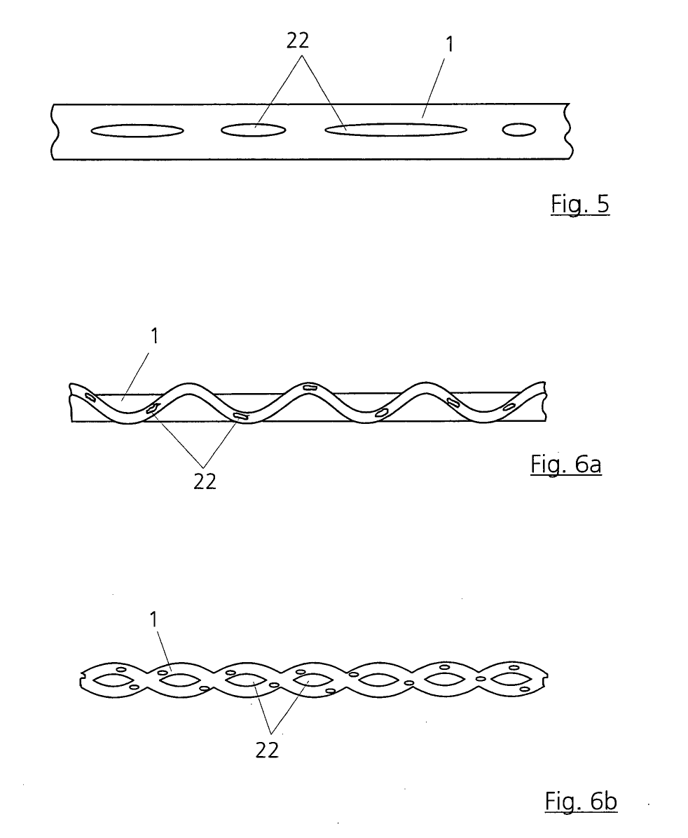

As can be seen from FIG. 5, provided between the cutting elements 18 are clearances or openings 22, which are distributed over the circumference of the separating body 1 in the circumferential wall and may be of different lengths and sizes in order that they likewise counteract the occurrence of vibrations. At the same time, cooling lubricant can be introduced via these clearances or openings 22.

Similar configurations are represented in FIGS. 6a and 6b. In addition, however, here the circumferential region of the separating body 1 is formed in a wave form, to be even less harmful to crystal structures. The spatial frequency of the wave preferably varies stochastically over the circumference of the separating body. This suppresses the resonant response for a single frequency in the workpiece. According to FIG. 6a, a single wave form with openings 22 is represented. A counter-running double wave with stochastic frequency variation, as represented in FIG. 6b, is very advantageous for vibration suppression.

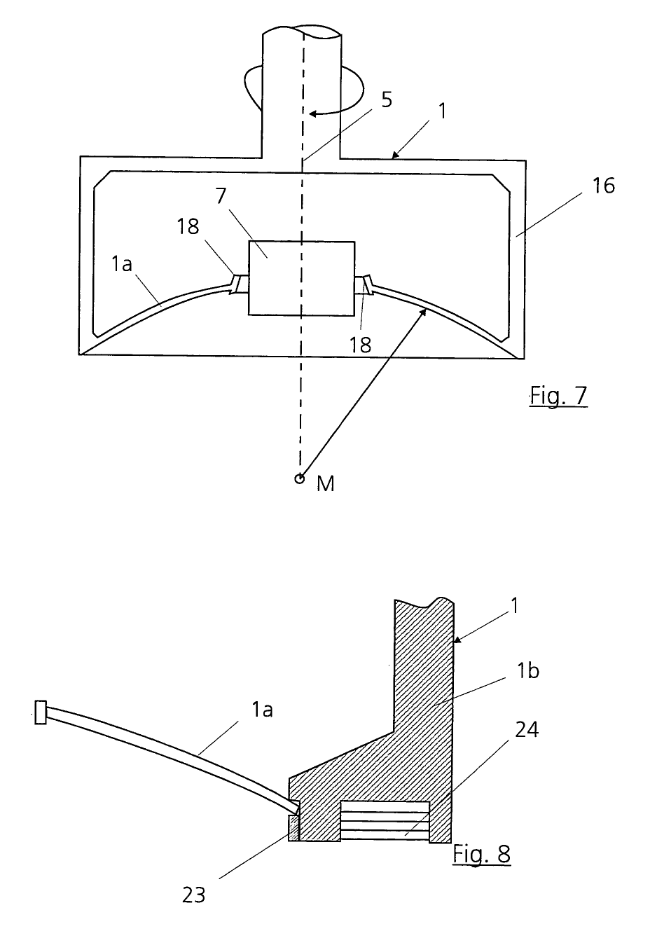

Represented in FIG. 7 is a configuration of the separating body 1 which has a part-spherical shell la in the form of a spherical curved ring, which has a radius with a curvature center point M, with a large bore in the region of the pivoting axis 5. On the inner circumference of the part-spherical shell 1a there are the cutting elements 18. The optical element, that is the basic body 7, to be produced is introduced into the bore. The basic body 7 is mounted and held in the same way as represented in FIG. 1 and hereafter also in FIG. 14.

At its outer circumference, the part-spherical shell 1a is connected to a cylindrical housing 1b of the separating body 1. This advantageously takes place by means of a holding device in the form of a clamping device 23, in order to achieve rapid detachability and consequently exchangeability of the part-spherical shell 1a. In this way, basic bodies 7 with different dimensions and with different radii of curvature can be produced in a quick and simple way in the same device.

In FIG. 8, the clamping device 23 is merely represented in principle. A wide variety of devices may be used for this purpose. FIG. 8 also reveals damping elements 24 in the form of damping rings in the cylindrical housing 1b of the separating body 1, which are intended to damp vibrations occurring. The damping rings may consist, for example, of gray cast iron adhesively bonded in rubber. The cylindrical housing 1b may also be a cast-iron pot or ring which is three-dimensionally balanced.

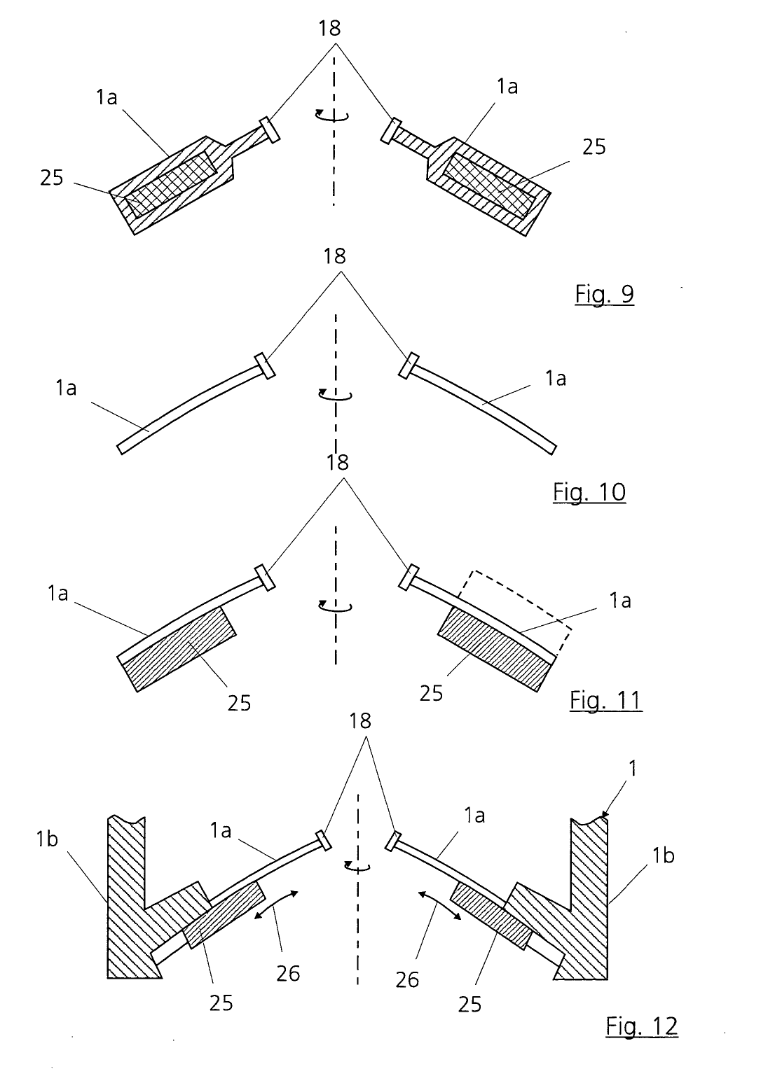

When machining crystals, such as calcium fluoride, magnesium fluoride, lithium fluoride or sodium fluoride, the first contact of the cutting elements 18 with the basic body 7 is problematical or fraught with risk. According to FIGS. 9 and 10, machining therefore takes place with two different part-spherical shells 1a.

The first incision is carried out with one part-spherical shell 1a, which is provided with a thickening in which a damping element 25 is integrated. In this way, vibration damping is achieved. However, the incision can only be carried out as far as the beginning of the thickening. Subsequently, the part-spherical shell 1a according to FIG. 9 is exchanged for a part-spherical shell according to FIG. 10, which is formed with thin walls over the entire length.

FIG. 11 shows a similar configuration of a part-spherical shell 1a, like the part-spherical shell represented in figure 9. In this case, however, damping elements 25 are not integrated into the part-spherical shell 1a but are arranged on one curved side. If need be, damping elements may also be provided on both sides, as indicated in the right-hand representation of FIG. 11 by dashed lines.

FIG. 12 shows a configuration of a part-spherical shell 1a with damping elements 25 in a form similar to that represented in FIG. 11. As a difference from the latter, however, the damping elements according to FIG. 12 are displaceable in the radial direction according to the arrows 26. The damping elements 25 can in this case be pushed back, if appropriate, over guides as far as the cylindrical housing 1b of the separating body 1, so that the cut can be introduced deeper into the basic body 7. If the damping elements 25 can be retracted completely, a complete separating cut can be carried out with a single part-spherical shell 1a.

It goes without saying that the damping elements 25 should also be three-dimensionally balanced.

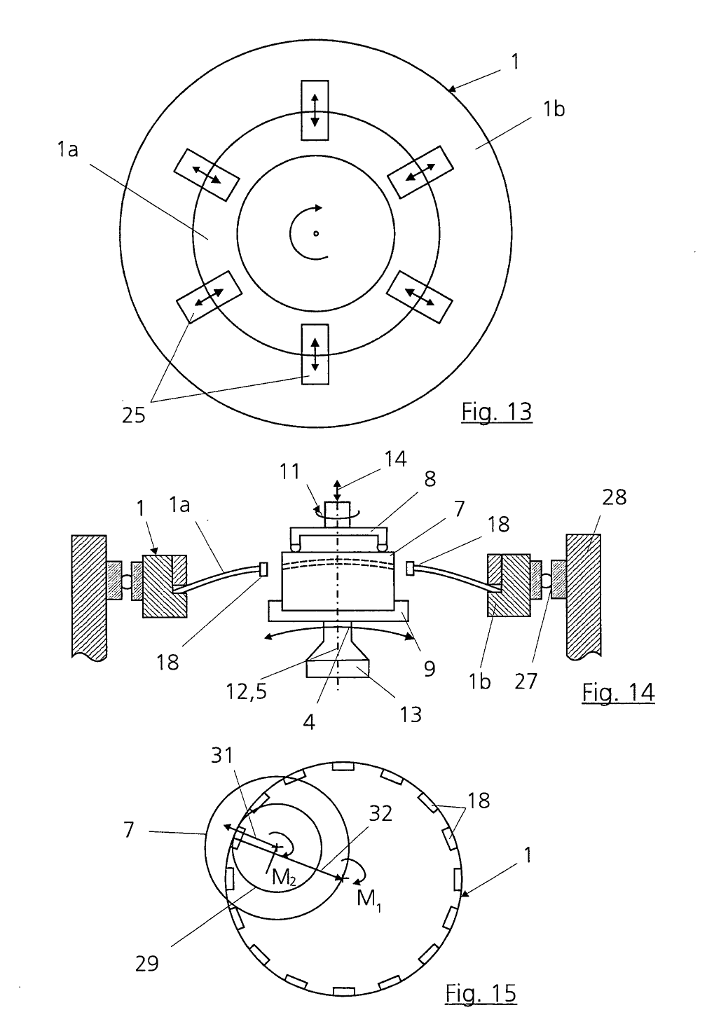

Represented in FIG. 13 is a plan view of the part-spherical shell 1a with the displaceable damping elements 25, which are arranged such that they are spaced apart from one another and distributed over the circumference. To reduce vibrations, preferably a prime-number arrangement, with for example 5, 7 or 11 damping elements 25, may be provided.

The damping elements 25 can be displaced individually or else jointly in the radial direction according to the arrows by means of adjusting elements not represented. If vibration sensors (not represented) are used for monitoring vibrations occurring, unbalances of the tool, i.e. of the separating body 1, can be minimized in real time with a corresponding closed-loop control.

This method is comparable with a jaw chuck of a lathe. The damping elements 25 may, however, also be displaced jointly under open-loop control.

Damping measures described on the basis of FIGS. 3 to 6 can also be realized in the case of the exemplary embodiment with the part-spherical shell 1a as a spherical curved ring with the cylindrical housing 1b.

FIG. 14 shows in principle the construction of a device for a separating body 1 according to FIG. 7. In principle, the construction of the device is comparable with the device described in FIG. 1, for which reason the same reference numerals have also be retained here for the same parts. The main difference lies in the mounting on the outer side of the separating body 1 with a cylindrical housing 1b by means of a bearing point in the form of a ball bearing 27 with respect to a part 28 of the device fixed to the machine. The rotary drives for the receptacle 9 by means of the drive device 13 around the rotating axis 12 and for the receptacle 8 on the other side of the basic body 7 must be synchronous. Similarly, there must be a joint pivoting movement of the receptacle 8, which may for example be a suction bell which is operated under negative pressure, and of the drive device 13. The pivoting axis 5 and the rotating axis 12 must therefore be identical. The separating body 1 likewise rotates, it of course being possible for a sliding bearing or an air or liquid bearing to be provided instead of the ball bearing 27 represented.

The axis of symmetry or pivoting axis 5 is preferably parallel or perpendicular to the force of gravity. Instead of a conventional drive for the separating body 1, the cylindrical housing 1b may be driven, for example, by direct introduction of electromagnetic forces. In this case, the cylindrical housing 1b is itself the motor, i.e. rotor or stator, in the manner of a linear motor. In this way, vibrations introduced are reduced still further by fewer moving components.

Depending on the radius to be introduced into the basic body 7, and consequently also the radius of the part-spherical shell 1a, the receptacle 9 for the basic body 7 and also the receptacle 8 are displaced by means of a steering carriage not represented. The longitudinal axis of the basic body 7 is located on the pivoting axis 5.

Since the receptacle or mounting for the separating body 1 is itself a single unchangeable acquisition, generally most of the relative movement of the cuts will be provided via the receptacle of the separating body 1 by a corresponding drive of the receptacle. Depending on the type of engagement opening, the workpiece, that is the basic body 7, must then either not rotate at all or only rotate slowly.

FIG. 15 reveals in a basic representation the cutting method for introducing a spherical cut into a basic body 7 with a device according to FIG. 14. Represented in this case are the outline of the basic body 7 and of the part-spherical shell 1a in the region of the bore with the cutting elements 18 together with a curve of intersection 29 in the basic body 7. The center point M₁ of the cutting separating body 1 and center point M₂ of the basic body 7 lie on one side with respect to the cutting event. The curve of intersection and the cutting tools, that is the cutting elements 18, produce contact angles with small aperture, since the two circles meet tangentially, the center points of curvature lying distinctly apart.

When the cut is introduced, the circle of the curve of intersection 29 becomes increasingly smaller, until it becomes 0. As this happens, the basic body 7 moves outward in the direction of the arrow 31 or the separating body 1 moves in the opposite direction in the direction of the arrow 32, it also being possible for the two movements to be combined.

The two rotating axes M₁ and M₂ have a common point of intersection, which in the representation according to FIG. 15 lies outside the plane of the drawing. The common point of intersection is the fixed rotating point about which either the basic body 7 or the separating body 1 is pivoted in order to carry out the separating cut.

The pitch during the spherical separation has the same algebraic sign for the curve of the cutting elements 18 and the curve of intersection 29 of the workpiece.

Depending on the type and size of the separating body 1 and of the basic body 7, the required pivoting movement will be carried out around the pivoting axis 5 with the center point M, by corresponding pivoting either of the separating body 1 or of the basic body 7. In the case of the configuration according to FIG. 1, in which the cutting elements 18 are located on the outer circumference of the separating body 1, the separating body 1 will be pivoted through the basic body 7—as represented. In the case of the configuration corresponding to FIGS. 7 to 14, in which the cutting elements 18 are located on the inner circumference of the part-spherical shell 1a, the basic body 7 will be arranged on a pivoting element, corresponding to the pivoting element 3, and pivoted through the separating body 1.

What is claimed is:

1. A method for producing an optical element with at least one curved surface by spherical separation from a basic body with a spherical-cap-like separating body with cutting elements, said separating body being moved through said basic body or said basic body being moved through said separating body, while at the same time a relative rotational movement takes place between said basic body and said separating body with a rotating axis which passes through the center point (M) of the pivoting movement.

2. The method as claimed in claim 1, wherein said spherical-cap-like separating body rotates during the separating cut.

3. The method as claimed in claim 1, wherein said basic body rotates during the separating cut.

4. The method as claimed in claim 1, wherein at least two optical blanks for the optical element are removed from said basic body in such a way that a concave side of a first optical element and a convex side of a second optical element are formed simultaneously by a single separating cut.

5. The method as claimed in claim 4, wherein lenses are produced as optical elements.

6. The method as claimed in claim 5, wherein lenses are produced from quartz glass for projection lenses or lighting optics in microlithography.

7. The method as claimed in claim 5 wherein lenses are produced from crystals, such as calcium fluoride, barium chloride, magnesium fluoride or lithium fluoride, for projection lenses or lighting optics in microlithography.

8. A method for producing a lens for projection lenses or lighting optics in microlithography, with at least one curved surface by spherical separation from a basic body with a spherical-cap-like separating body with cutting elements, said separating body being moved through said basic body or said basic body being moved through said separating body, while at the same time a relative rotational movement takes place between said basic body and said separating body with a rotating axis which passes through the center point (M) of the pivoting movement.

9. The method as claimed in claim 8, wherein said spherical-cap-like separating body rotates during the separating cut.

10. The method as claimed in claim 8, wherein said basic body rotates during the separating cut.

11. The method as claimed in claim 8, wherein at least two optical blanks for the optical element are removed from said basic body in such a way that a concave side of a lens and a convex side of a lens are formed simultaneously by a single separating cut.

12. A device for producing an optical element with at least one curved surface from a basic body, with a spherical-cap-like separating body with cutting elements, said separating body or said basic body being pivotable around a pivoting axis with a curvature about a pivoting point (M) which corresponds to the curvature of the separating cut to be introduced into said basic body, and said basic body being accommodated in at least one receptacle.

13. The device as claimed in claim 12, wherein said basic body is accommodated rotatably around its longitudinal axis in at least one receptacle.

14. The device as claimed in claim 12, wherein said separating body is provided with a drive device, with a rotating axis which passes through the center point (M) of the pivoting movement.

15. The device as claimed in claim 12, wherein the optical elements to be produced are lenses, said spherical-cap-like separating body having a part-spherical shell and it being possible to remove from the basic body at least two optical blanks for lenses in such a way that a concave side of a first lens and a convex side of a second lens can be produced simultaneously by the separating cut.

16. The device as claimed in claim 15, wherein said separating body has a part-spherical shell in at least approximately the form of a bell, said cutting elements being arranged on the outer circumference of the part-spherical shell.

17. The device as claimed in claim 15, wherein said separating body has a part-spherical shell, which is provided in the region of the pivoting axis of said separating body with a bore in which said basic body can be accommodated with its receptacle, and wherein said part-spherical shell is held on its outer circumferential wall on said separating body by means of a holding device, said cutting elements being arranged on the inner circumference of said part-spherical shell.

18. The device as claimed in claim 17, wherein the holding device for the part-spherical shell has a clamping device, detachably connecting said part-spherical shell to said separating body.

19. The device as claimed in claim 18, wherein the region of said separating body with which said part-spherical shell is connected via said clamping device is formed at least approximately as a cylindrical housing.

20. The device as claimed in claim 19, wherein said cylindrical housing is supported by a rotary bearing on a device fixed to the machine.

21. The device as claimed in claim 19, wherein said cylindrical housing is provided with damping elements.

22. The device as claimed in claim 17, wherein said part-spherical shell is provided with damping elements.

23. The device as claimed in claim 22, wherein one or more damping elements are integrated into said part-spherical shell or connected to it.

24. The device as claimed in claim 23, wherein said damping elements are arranged on one or both sides of the part-spherical shell.

25. The device as claimed in claim 24, wherein said damping elements are arranged displaceably in the radial direction on said part-spherical shell.

26. The device as claimed in claim 25, wherein said damping elements are displaceable individually under open-loop or closed-loop control by sensors which pick up vibrations of said part-spherical shell.

27. The device as claimed in claim 12, wherein said basic body is accommodated at both ends in receptacles pneumatically, mechanically, hydraulically or magnetically.

28. The device as claimed in claim 27, wherein one of said two receptacles is provided with a rotary drive device and the other receptacle is provided with a follower device.

29. The device as claimed in claim 27, wherein said receptacles are displaceable in the direction of the rotating axis, which passes through the center point (M) of the pivoting movement.

30. The device as claimed in claim 12, wherein said basic body is under an axial tensile force in the at least one receptacle in a clamped state during the separating cut.

31. The device as claimed in claim 12, wherein said separating body with its cutting elements arranged on the circumference of said separating body has a vibration-damping construction.

32. The device as claimed in claim 12, wherein said separating body is divided into two or more parts.

33. The device as claimed in claim 12, wherein said separating body is provided on at least one of its surfaces with depressions.

34. The device as claimed in claim 33, wherein said depressions are formed as grooves.

35. The device as claimed in claim 33, wherein said depressions pass completely through said separating body.

36. The device as claimed in claim 34, wherein said grooves are distributed irregularly over said separating body.

37. The device as claimed in claim 34, wherein said grooves are provided for transporting flushing fluid to said cutting elements.

38. The device as claimed in claim 12, wherein said cutting elements are arranged irregularly on said separating body.

39. The device as claimed in claim 12, wherein said cutting elements are formed in a wedge-shaped manner in cross section, the wider side of the wedge being located on the outside.

40. The device as claimed in claim 12, wherein said separating body is provided with clearances or bores in its circumferential wall.

41. A device for producing lenses for projection optics and lighting optics in microlithography with at least one curved surface from a basic body, with a spherical-cap-like separating body with cutting elements, said separating body or said basic body being pivotable around a pivoting axis with a curvature about a pivoting point (M) which corresponds to the curvature of the separating cut to be introduced into said basic body, and said basic body being accommodated in at least one receptacle.

42. The device as claimed in claim 41, wherein said basic body is accommodated rotatably around its longitudinal axis in at least one receptacle.

43. The device as claimed in claim 41, wherein said separating body is provided with a drive device, with a rotating axis which passes through the center point (M) of the pivoting movement.

44. The device as claimed in claim 41, wherein said spherical-cap-like separating body having a part-spherical shell and it being possible to remove from the basic body at least two optical blanks for lenses in such a way that a concave side of a first lens and a convex side of a second lens can be produced simultaneously by the separating cut.
